(19) United States
(12) Patent Application Publication
(10) Pub. No.: US 2013/0231944 A1
(43) Pub. Date: Sep. 5, 2013

(54) Evaluation of Medical Therapy Design Assumptions Based on Trial Outcomes

(71) Applicant: MEDTRONIC, INC., Minneapolis, MN (US)

(72) Inventors: Richard E. Kuntz, Minneapolis, MN (US); Kmberly A. Oleson, Shoreview, MN (US)

(73) Assignee: Medtronic, Inc., Minneapolis, MN (US)

(21) Appl. No.: 13/760,862

(22) Filed: Feb. 6, 2013

Related U.S. Application Data
(60) Provisional application No. 61/605,451, filed on Mar. 1, 2012.
(60) Provisional application No. 61/636,993, filed on Apr. 23, 2012.

(51) Int. Cl. G06Q 10/06; G06Q 50/22

(52) U.S. Cl. CPC G06Q 10/0635; G06Q 50/22
USPC 705/2

(57) ABSTRACT

A computing system receives design assumption data prior to a trial of a medical therapy. The design assumption data indicate design assumptions regarding clinical outcomes that are potentially associated with the medical therapy. In addition, the computing system receives trial outcome data that indicate clinical outcomes experienced by participants in the trial of the medical therapy. The computing system generates data that associate the design assumptions with the clinical outcomes experienced by the participants.

### BACKGROUND

When a medical therapy is designed, engineers may identify their design assumptions regarding the medical therapy. The design assumptions may indicate the engineers' assumptions regarding risks that the medical therapy or its subsystems may affect particular clinical outcomes. For example, one of the design assumptions may indicate the estimated risk of a particular subsystem of the medical therapy causing an infection in a patient or how long the medical therapy, or its components, is expected to last. In addition, the design assumptions may indicate assumptions regarding measures taken to mitigate the risks. The engineers then prepare a risk assessment document that indicates their design assumptions regarding the medical therapy. Certain international standards, such as International Organization for Standardization (ISO) standards no. 14971 and no. 14155, specify requirements for the preparation of such a risk assessment document.

Subsequently, a trial may be performed on the medical therapy. For example, a clinical trial may be performed on the medical therapy. During the trial, the medical therapy may be used on human participants. Clinical outcomes experienced by the participants are recorded. The medical therapy may be approved or rejected for marketing to the public based on the clinical outcomes experienced by the participants.

### SUMMARY

This disclosure describes techniques for evaluating a medical therapy. According to the techniques, a computing system receives design assumption data prior to a trial of the medical therapy. The design assumption data indicate assumptions regarding clinical outcomes that are potentially associated with the medical therapy. In addition, the computing system receives trial outcome data that indicate clinical outcomes experienced by participants in the trial of the medical therapy. The computing system generates data associating the design assumptions with the clinical outcomes experienced by the participants in the trial.

By generating data that associate the design assumptions with the clinical outcome data generated during the trial, engineers may, in some examples of the techniques of this disclosure, be able to evaluate the accuracy of the design assumptions included in a risk assessment document for the medical therapy. By evaluating the accuracy of the design assumptions included in the risk assessment document, the engineers may be able to identify the sources of risks of clinical outcomes, such as those observed in the trial. Furthermore, if engineers use a particular subsystem in the designs of other medical therapies and a design assumption regarding the particular subsystem proves to be inaccurate, the engineers may be able to efficiently modify their design assumptions regarding the other medical therapies.

In some examples, this disclosure describes a method for evaluating a medical therapy. The method comprises receiving, in a computing system, design assumption data prior to a trial of the medical therapy. The design assumption data indicates design assumptions regarding clinical outcomes that are potentially associated with the medical therapy. The method also comprises receiving, in the computing system, trial outcome data that indicate clinical outcomes experienced by participants in the trial of the medical therapy. In addition, the method comprises generating, by the computing system, data associating the design assumptions with the clinical outcomes experienced by the participants in the trial.

In some examples, this disclosure describes a computing system that comprises a data storage system that stores computer-executable instructions. The computing system also comprises one or more processing units coupled to the data storage system. The one or more processing units are configured to execute the instructions. Execution of the instructions by the one or more processing units configures the computing system to receive design assumption data prior to a trial of a medical therapy. The design assumption data indicates design assumptions regarding clinical outcomes that are potentially associated with the medical therapy. Execution of the instructions may also configure the computing system to receive trial outcome data that indicate clinical outcomes experienced by participants in the trial of the medical therapy. Execution of the instructions may also configure the computing system to generate data associating the design assumptions with the clinical outcomes experienced by the participants in the trial.

In some examples, this disclosure describes a computer storage medium that stores computer-executable instructions. Execution of the instructions by one or more processing units of a computing system configures the computing system to receive design assumption data prior to a trial of the medical therapy. The design assumption data indicates design assumptions regarding clinical outcomes that are potentially associated with the medical therapy. Execution of the instructions also configures the computing system to receive trial outcome data that indicate clinical outcomes experienced by participants in the trial of the medical therapy. In addition, execution of the instructions configures the computing system to generate data associating the design assumptions with the clinical outcomes experienced by the participants in the trial.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual diagram that illustrates an example environment in which the techniques of this disclosure may be implemented.

FIG. 2 is a conceptual block diagram that illustrates an example configuration of a computing system in which the techniques of this disclosure may be implemented.

FIG. 3 is a flowchart that illustrates an example operation performed by a design team for a medical therapy.

FIG. 4 is a flowchart that illustrates an example operation performed by a trial team for the medical therapy.

FIG. 5 is a flowchart that illustrates an example operation performed by an evaluation team for the medical therapy.

FIG. 6 is a flowchart that illustrates an example operation performed by the computing system.

FIG. 7 is a conceptual block diagram that illustrates an example configuration of a computing device.

### DETAILED DESCRIPTION

The attached drawings illustrate examples. Elements indicated by reference numbers in the attached drawings correspond to elements indicated by like reference numbers in the following description. In the attached drawings, stacked elements indicate the presence of one or more similar elements. In this disclosure, elements having names that start with ordinal words (e.g., “first,” “second,” “third,” and so on) do not necessarily imply that the elements have a particular order. Rather, such ordinal words are merely used to refer to different elements of a same or similar type.

This disclosure describes techniques for evaluating a medical therapy. For instance, a computing system may receive design assumption data prior to a trial of the medical therapy. The design assumption data may indicate design assumptions regarding clinical outcomes that are potentially associated with the medical therapy. For example, a design assumption associated with a particular design feature may indicate that there is a risk that a flaw or unintended use of the design feature may cause a patient to experience a particular adverse effect. In addition, the computing system may receive trial outcome data. The trial outcome data may indicate clinical outcomes experienced by participants in a trial of the medical therapy. The clinical outcomes may include adverse outcomes and positive outcomes. The computing device may generate data that associate the design assumptions with the clinical outcomes experienced by the participants.

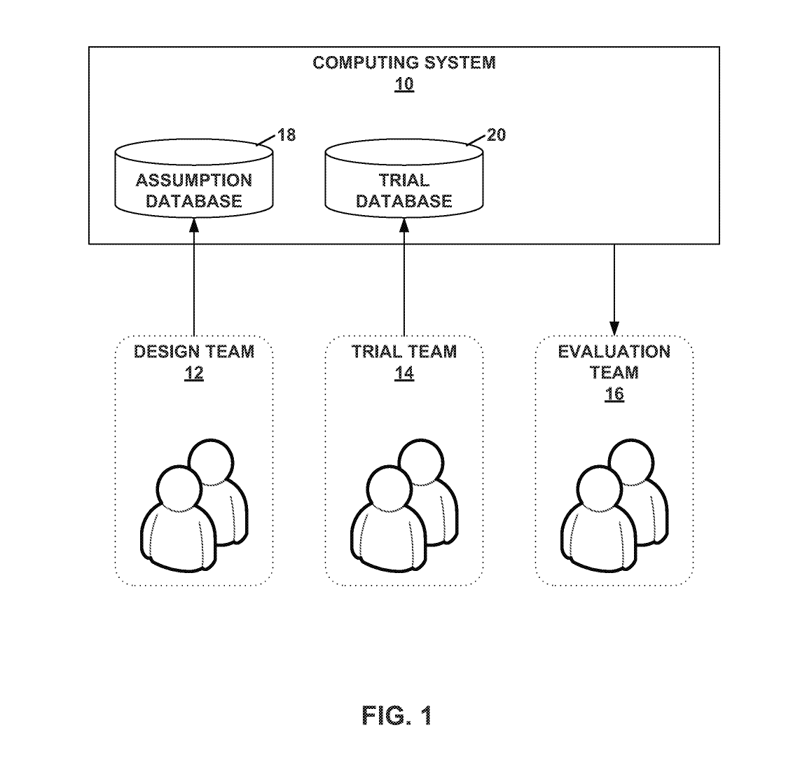

FIG. 1 is a conceptual diagram that illustrates an exemplary environment in which the techniques of this disclosure may be implemented. As illustrated in the example of FIG. 1, the environment may include a computing system 10, a design team 12, a trial team 14, and an evaluation team 16. In some examples, the memberships of design team 12, trial team 14, and evaluation team 16 may overlap. In other examples, the memberships of design team 12, trial team 14, and evaluation team 16 do not overlap. In other examples, the roles provided by design team 12, trial team 14, and/or evaluation team 16 may be performed by other teams of people.

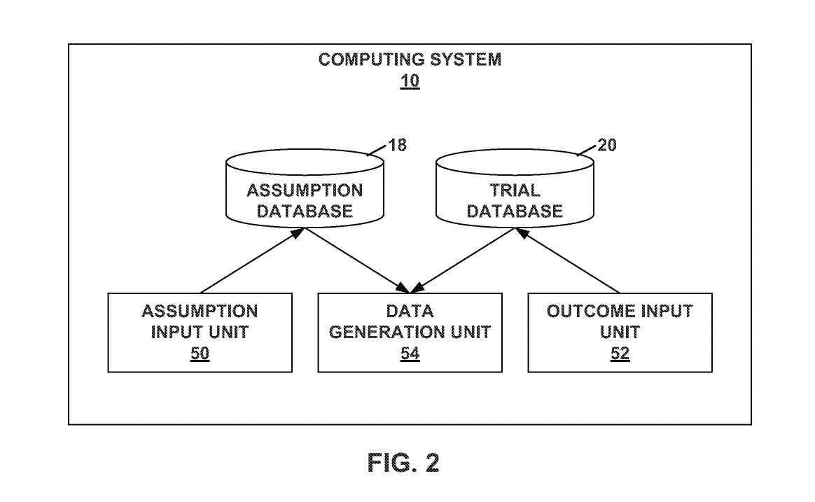

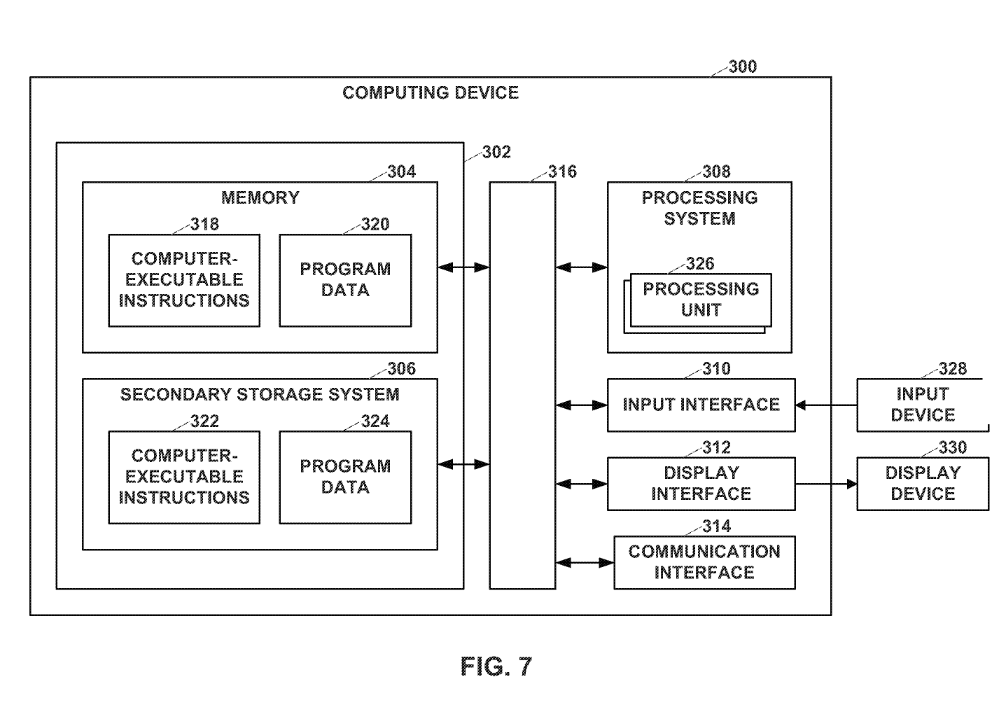

Computing system 10 may be a system of one or more computing devices. In various examples, computing system 10 may include various types of computing devices. For example, computing system 10 may include one or more standalone server devices, rack server devices, personal computers, or other types of computing devices. FIG. 2, described in detail below, describes example conceptual components of computing system 10. FIG. 7 described in detail below, describes an example configuration of a computing device that may be included in computing system 10.

Design team 12 is a group of one or more people who are responsible for designing a medical therapy. Design team 12 may be responsible for designing various types of medical therapies. For example, design team 12 may design a medical device, such as a neurostimulation device, a surgical tool, a stent, a cardiac rhythm management device, a catheter, a shunt, an orthopedic device, an implantable drug pump, a diagnostic device, or another type of implantable or non-implantable medical device. In another example, design team 12 may design a system, such as a software system, for diagnosing a medical condition. In another example, design team 12 may design a surgical procedure or a course of treatment.

Design team 12 may also generate design assumption data that indicate design assumptions regarding clinical outcomes that are potentially associated with the medical therapy. Design team 12 may input the design assumption data to computing system 10. When computing system 10 receives the input of the design assumption data, computing system 10 may store the design assumption data in an assumption database 18.

In some examples, the design assumption data may indicate design assumptions regarding clinical outcomes that may be potentially caused by the medical therapy or subsystems thereof. In this disclosure, the term “subsystem” may refer generically to subcomponents of a medical therapy and systems of subcomponents within the medical therapy. In some examples, the design assumption data may indicate design assumptions regarding usage instructions to a patient regarding the medical therapy. Furthermore, in some examples, the design assumption data may indicate design assumptions regarding usage instructions to physicians regarding the medical therapy. Example usage instructions may include a variety of instructions for delivery of a medical therapy, implantation or installation of a device, other surgical procedures, dosage instructions, programming or configuration instructions of a device, monitoring and maintenance instructions for a device, and the like.

Example types of subsystems may include, without limitation, design characteristics of housings, leads, conductors, electrodes, sensors, detection algorithms, batteries, power supplies, antennas, telemetry circuits, catheters, fluid pumps, fluid reservoirs, therapeutic agents, such as pharmaceutical agents, biological agents, delivery systems, programming interfaces, processes, techniques or procedures, and the like.

Moreover, the design assumptions may include design assumptions regarding measures taken to mitigate risks of particular clinical outcomes. For example, a design assumption may indicate that a particular sterilization technique is sufficient to mitigate the risk of infection from a particular subsystem of the medical therapy. In another example, a design assumption may indicate that a usage instruction regarding how to attach an electrical lead of the medical therapy to a nerve is sufficient to mitigate the risk of damage to the nerve. The design assumptions regarding the medical therapy may include design assumptions regarding subsystems of the medical therapy, usage instructions regarding the medical therapy, and design assumptions regarding other aspects of the medical therapy.

The design assumption data may indicate various types of design assumptions regarding clinical outcomes potentially associated with the medical therapy. For example, the design assumption data may include design assumptions regarding electrical risks, mechanical risks, environmental risks, user-derived risks, non-user events, and biological risks. Mechanical risks may include risks of clinical outcomes caused by mechanical faults of the medical therapy. For instance, mechanical faults may include risks caused by broken pans, electrical shocks, and the like. Environmental risks may include risks of clinical outcomes caused by interactions between the medical therapy and an environment in which the medical therapy is used. For instance, environmental risks may include risks of clinical outcomes caused by interactions with other therapies, light, food, electromagnetic fields, temperature, pressure, and other factors in the environment of a user of the medical therapy. Example user-derived risks may include risks of clinical outcomes caused by a user of the medical therapy. For instance, user-derived risks may include risks associated with failing to follow dosage instructions, risks associated with the user improperly handling the medical therapy, and so on. Non-user events may include risks caused by people or things other than a user of the medical therapy. For instance, non-user events may include risks associated with a caregiver failing to follow instructions, electrical power failures, progranuning faults, and other events that are not caused by the user or the user's environment. Biological risks include risks of infection, cancer, adverse immune system response, and the like.

In one particular example, the design assumption data may indicate that a particular sterilization technique used during the manufacture of a subsystem of the medical therapy may reduce the risk of infection due to the subsystem to an acceptable level. In another example, the design assumption data may indicate that a particular amount of insulation on an electrical conductor of the medical therapy may be sufficient to reduce the risk of electrical shock to an acceptable level, such as a threshold number of shock events for a patient or among patients, a threshold magnitude level of a shock, or the like In yet another example, the design assumption data may indicate that if a surgeon uses a particular technique when implanting a device, structure, or element associated with the medical therapy, the risk of a particular complication is reduced to a particular level. In yet another example, the design assumption data may indicate that the medical therapy will compensate for or alleviate a patient's medical condition for a particular amount of time. The design assumptions may indicate that different subsystems may potentially be associated with the same clinical outcome.

In another example, the medical therapy may be a Magnetic Resonance Imaging (MRI)-compatible defibrillation lead. In this example, the MRI-compatible defibrillation lead may include an outer polymer layer and a metal shunt. In other words, the subsystems of the MRI-compatible defibrillation lead may include an outer polymer layer and a metal shunt. The design assumption data for the MRI-compatible defibrillation lead may include design assumption data regarding the outer polymer layer and the metal shunt. Both the design assumption data regarding the outer polymer layer and the design assumption data regarding the metal shunt may indicate a failure condition, an effect of the occurrence of the failure condition, a severity rating for the situation if the failure condition occurs, a potential cause of the failure condition, an occurrence rating that indicates a predicted probability of the failure condition occurring, a detection rating that indicates the probability of detecting the occurrence of the failure condition, a risk priority number (RPN), whether occurrence of the failure condition is acceptable, a safeguard against the occurrence of the failure condition, and a method for verifying that the failure condition does not occur. The process for identifying and mitigating risks can utilize quality tools such as a Failure Modes and Effects Analysis or similar. The severity rating, the occurrence rating, and the detection rating may be on scales from “1” to “10.” The RPN may be a product of multiplying the severity rating, the occurrence rating, and the detection rating.

In the example above, the design assumption data regarding the outer polymer layer may indicate that an elevated impedance level is a potential failure condition of the outer polymer layer. The design assumption data may also indicate that the effect of the failure condition occurring may be that the lead tips of the MRI-compatible defibrillator lead heat up to an undesirable temperature level when the lead is introduced into an MRI field. In addition, the design assumption data may specify a severity rating of the elevated impedance level is “3,” indicating that the elevated impedance level may cause a condition of relatively minor severity. The design assumption data may also indicate that a potential cause of the elevated impedance level is that the insulation of the outer polymer layer is too thick or the presence of different dielectric thicknesses with poor capacitive properties within the insulation of the polymer layer. Furthermore, the design assumption data may specify that an occurrence rating of “3,” indicating that there is a relatively low risk of the elevated impedance level occurring. The design assumption data may also specify a detection rating of “4,” indicating a moderate-to-high probability of being able to detect the elevated impedance level. The design assumption data may specify that the RPN is “36” (i.e., 3×3×4=36). The design assumption data regarding the outer polymer lead may also indicate that the elevated impedance level is unacceptable. In addition, the design assumption data regarding the outer polymer layer may indicate that ensuring that the dimensions of a dielectric in the insulation of the polymer layer are not too thick in order to allow adequate capacitive coupling is a safeguard against the elevated impedance level. The design assumption data may also specify that the planned method of verifying that the elevated impedance level does not occur is radio frequency (RF) injection testing or lead inspection.

Furthermore, in the example above, the design assumption data regarding the metal shunt may indicate that corrosion byproducts are a potential failure condition of the metal shunt. The design assumption data may also indicate that intermittent or total loss of sensing/capture and oversensing are potential effects of corrosion byproducts. In addition, the design assumption data may specify a severity rating of “5,” indicating that the corrosion byproducts may cause the occurrence of a moderately severe condition. The design assumption data may also specify an occurrence rating of “3,” thereby indicating a relatively low likelihood of the corrosion byproducts occurring. The design assumption data may also specify a detection rating of “2,” indicating that occurrence of corrosion byproducts are almost certain to be detected. The RPN specified by the design assumption data may be “30” (i.e., 5×3×2=30). The design assumption data for the metal shunt may indicate that occurrence of corrosion byproducts is unacceptable. In addition, the design assumption data for the metal shunt may indicate that ensuring an acceptable metal choice and adding a spring clip interconnector component to reduce electrical noise/metal-to-metal contact may be potential safeguards against the occurrence of corrosion byproducts. The design assumption data for the metal shunt may also indicate that corrosion testing is a planned method of verifying that corrosion byproducts do not occur.

In some examples, the design assumption data may take the form of a risk assessment document of the type required by International Organization for Standardization (ISO) standards no. 14971 and/or 14155. The Risk Assessment Document may identify some or all areas where there is potential for risk due to mechanical, electrical, environmental, logical, user and biological issues for the medical therapy and subcomponents of the medical therapy. Thus, when computing system 10 receives the design assumption data, computing system 10 may receive a risk assessment document that complies with a standard, the risk assessment document indicating the design assumptions for the medical therapy. In some examples, the risk assessment document may identify pre-established thresholds or boundaries for clinical outcomes associated with clinical outcomes. The clinical outcomes may be defined according to clinical outcome classifications that specify criteria for identifying and quantifying different types of adverse events.

Trial team 14 may design a trial database 20 to hold trial outcome data for the medical therapy. Computing system 10 may store trial database 20. As trial team 14 conducts a trial prior to receiving marketing approval for the medical therapy, trial team 14 inputs the trial outcome data into trial database 20. Trial team 14 may conduct various types of trials of the medial therapy. For example, trial team 14 may conduct a bench trial, a non-clinical trial, a clinical trial, or another type of trial of the medical therapy.

The trial outcome data may indicate clinical outcomes experienced by patients who participate in the trial of the medical therapy. For example, the trial outcome data may include data indicating that a particular trial participant experienced a clinical outcome, such as an unintended electrical shock from the medical therapy. For ease of explanation, this disclosure may refer to patients who participate in the trial of the medical therapy as trial participants. In another example, the trial outcome data may include data indicating that a particular trial participant experienced an infection at an implantation site of the medical therapy.

The design assumption data and the trial outcome data use the same definitions for clinical outcomes. Otherwise stated, the design assumption data and the trial outcome data may use the same lexicography to describe clinical outcomes. For example, a particular type of infection may potentially be associated with the medical therapy. In this example, the design assumption data may use a particular definition of the particular type of infection when indicating a design assumption regarding the particular type of infection. In this example, the trial outcome data may use the same particular definition of the particular type of infection when indicating that a trial participant experienced the particular type of infection. The same definition may use the same terminology, permitting the design assumption data and the clinical outcome data to be readily correlated by clinical outcome. Consequently, it may be possible to compare, in a consistent way, the clinical outcomes indicated by the design assumption data with the clinical outcomes indicated by the trial outcome data. Thus, consistency may be ensured across documents when data is updated in the trial or across multiple trial that use similar products. Furthermore, variability in classification of clinical outcomes, e.g., adverse event classification, within and across business units may introduce higher risks of identifying adverse events that exceed pre-established boundaries in a risk assessment document and may introduce delays in reporting of adverse events to regulatory agencies. Using a common set of definitions may reduce such risks and delays.

Computing system 10 generates data that associate the design assumptions with the clinical outcomes experienced by the trial participants. This data may indicate relationships between the clinical outcomes actually experienced by the trial participants and the clinical outcomes identified in the design assumptions as being potentially associated with the medical therapy. In various examples, computing system 10 may generate various types of data that associate the design assumptions with the clinical outcomes experienced by the trial participants. For example, computing system 10 may generate a list of the design assumptions regarding the clinical outcomes experienced by the trial participants. In another example, trial participants may be experiencing an adverse clinical outcome, such as an unintended electric shock or infection. In this example, computing system 10 may generate data indicating subsystems of the medical therapy potentially associated with the adverse clinical outcome.

Computing system 10 or evaluation team 16 may use the data generated by computing system 10 to evaluate the design assumptions for the medical therapy. By evaluating the design assumptions, computing system 10 or evaluation team 16 may identify potential sources of risks of the clinical outcomes observed in the trial. For example, the design assumption data may indicate a design assumption that a particular amount of insulation on an electrical conductor of the medical therapy is sufficient to reduce the risk of unintended electrical shock to an acceptable level. In this example, computing system 10 may generate data that associate this design assumption with the occurrence of electrical shocks experienced by trial participants. Furthermore, in this example, computing system 10 or evaluation team 16 may use the data generated by computing system 10 to evaluate whether a design assumption is accurate. In this example, if trial participants are experiencing unintended electrical shocks at an unacceptable rate, computing system 10 or evaluation team 16 may determine that the design assumption is incorrect and may need to be modified. In some instances, design team 12 may be asked to modify a design of the medical therapy due to a reevaluation of one or more design assumptions regarding the medical therapy.

In some instances, a particular type of subsystem may be used in multiple medical therapies. For example, a particular type of battery may be used in implantable pacemakers and implantable drug pumps. When the same subsystem is used in multiple medical therapies, the design assumptions regarding the subsystem may be applicable to each of the medical therapies. Hence, if computing system 10 or evaluation team 16 determines that a design assumption regarding the subsystem is inaccurate, computing system 10 may be able to identify the other medical therapies that include the subsystem. Design teams for the other medical therapies may then determine whether to modify the designs of the other medical therapies.

FIG. 2 is a conceptual diagram that illustrates an example configuration of computing system 10. As illustrated in the example of FIG. 2, computing system 10 comprises multiple functional components. The functional components include assumption database 18 and trial database 20. In addition, the functional components of computing system 10 include an assumption input unit 50, an outcome input unit 52, and a data generation unit 54. In other examples, computing system 10 may include more, fewer, or different functional components.

In various examples, assumption database 18 and trial database 20 may be implemented in various ways. For example, assumption database 18 and/or trial database 20 may be implemented as one or more relational databases. In this example, assumption database 18 and trial database 20 may be implemented as parts of the same relational database or in separate relational databases.

Assumption input unit 50 receives input of design assumption data from design team 12. Assumption input unit 50 may receive the design assumption data prior to the trial of the medical therapy. As discussed above, the design assumption data may indicate design assumptions regarding clinical outcomes that are potentially associated with the medical therapy.

Outcome input unit 52 receives input of trial outcome data from trial team 14. Outcome input unit 52 may receive input of the trial outcome data during or after the conclusion of the trial of the medical therapy. As discussed above, the trial outcome data may indicate clinical outcomes experienced by participants in the trial of the medical therapy.

In some examples, computing system 10 may receive data from and send data to computing devices used by members of design team 12, trial team 14, and evaluation team 16. For instance, computing system 10 may receive design assumption data and trial outcome data from computing devices used by design team 12 and trial team 14, e.g., via a network. In this way, computing system 10 may appear, from the perspective of design team 12, trial team 14, and evaluation team 16, to exist in “the cloud.”

Data generation unit 54 generates data associating the design assumptions regarding the medical therapy with the clinical outcomes experienced by the participants in the trial of the medical therapy. Data generation unit 54 may use data from assumption database 18 and trial database 20 to generate the data. In various examples, data generation unit 54 generates the data at various times. For example, data generation unit 54 may generate the data while the trial is ongoing. In another example, data generation unit 54 may generate the data after the conclusion of the trial.

In some examples, assumption database 18 and/or trial database 20 may be implemented using one or more data warehouses. For instance, trial outcome data may be stored in a data warehouse. A data warehouse may be a database used for reporting and analysis. In some examples, data generation unit 54 may perform a data mining operation on the data warehouse to determine patterns of clinical outcomes in the trial participants. Such data mining may be performed for premarket study purposes.

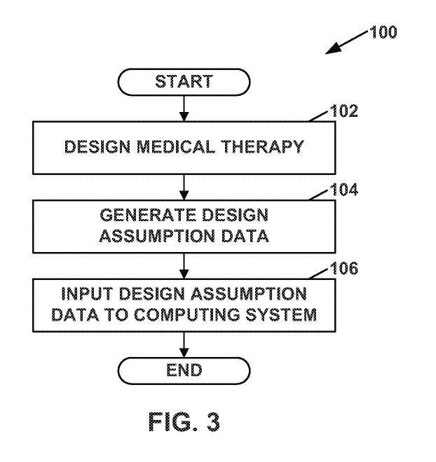

FIG. 3 is a flowchart that illustrates an example operation 100 performed by design team 12 for the medical therapy. After design team 12 begins operation 100, design team 12 may design the medical therapy (102). Designing the medical therapy may involve identifying a medical problem, identifying a potential solution to the medical problem, and designing a physical device or other type of therapy that realizes the potential solution. Designing the physical medical device or other type of therapy may involve the selection or design of subsystems, design of processes to manufacture and store the medical therapy and its subsystems, preparation of usage instructions for the medical therapy, and so on.

Furthermore, design team 12 may generate design assumption data (104). As discussed above, the design assumption data may indicate design assumptions regarding clinical outcomes that are potentially associated with the medical therapy. When design team 12 generates the design assumption data, design team 12 may use the definitions provided in a particular set of definitions to classify the clinical outcomes. For example, the set of definitions may provide precise definitions of terms such as electrical shock, infection, seizure, stroke, etc. Consequently, if the design assumption data uses a particular term to refer to a particular clinical outcome, a reviewer of the design assumption data may be able to use the set of definitions to determine exactly what the term means. In some instances, selection of particular design features may rely on design assumptions with respect to avoidance of adverse events.

In various examples, design team 12 may use the definitions provided by various sets of definitions to classify the clinical outcomes. For example, design team 12 may use dictionaries or biomedical vocabularies to classify the clinical outcomes. Example dictionaries and biomedical vocabularies include, but are not limited to the Medical Dictionary for Regulatory Activities (MedDRA), the Systematized Nomenclature of Medicine (SNOMED), SNOMED CT, the Unified Medical Language System®, and the Unified Medical Language System Metathesaurus®.

Design team 12 may then input the design assumption data to computing system 10 (106). In various examples, design team 12 may input the design assumption data to computing system 10 in various ways. Hence, computing system 10 may receive the design assumption data from design team 12 via an input interface, such as assumption input unit 50. For example, design team 12 may generate a spreadsheet or other file that specifies the design assumptions for the medical therapy. In this example, design team 12 may input the design assumption data to computing system 10 by uploading the spreadsheet to computing system 10. In this example, assumption input unit 50 (FIG. 2) may parse the design assumption data from the spreadsheet and insert the design assumption data into assumption database 18. In some instances, assumption input unit 50 may adapt or modify the inputted design assumption data when assumption input unit 50 inserts the design assumption data into assumption database 18. In another example, assumption input unit 50 may provide one or more electronic forms to design team 12. In this example, design team 12 may input the design assumption data to computing system 10 by entering the design assumption data into fields of the electronic forms. Assumption input unit 50 may insert the design assumption data from the electronic forms into assumption database 18.

Although the example of FIG. 3 shows operation 100 as a linear sequence of steps, design team 12 may perform the steps of operation 100 in a non-linear manner. For example, design team 12 may generate the design assumption data while design team 12 is designing the medical therapy. In another example, design team 12 may input design assumption data to computing system 10 while designing the medical therapy and may update the design assumption data as design team 12 refines the design of the medical therapy.

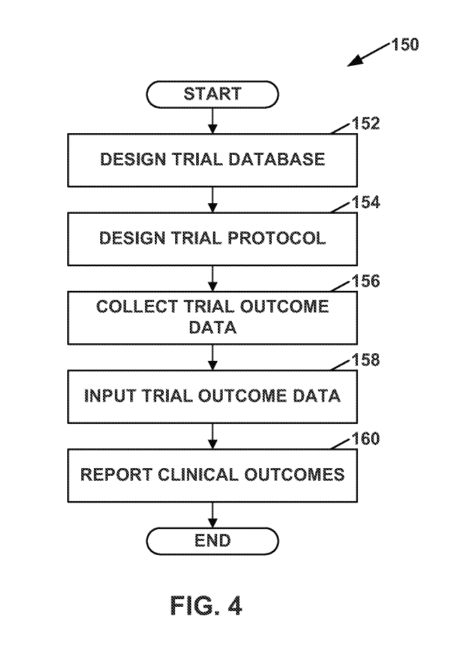

FIG. 4 is a flowchart that illustrates an example operation 150 performed by trial team 14 for the medical therapy. After trial team 14 starts operation 150, trial team 14 may design trial database 20 (152). Trial team 14 may design trial database 20 such that trial database 20 is able to store data regarding clinical outcomes that trial participants may potentially experience. For example, trial team 14 may use the design assumption data to identify clinical outcomes that are potentially associated with the medical therapy. Trial team 14 may then design a schema for trial database 20. The schema for trial database 20 may specify one or more tables of trial database 20 and formats for the tables. The tables may include rows or columns associated with the identified clinical outcomes that are potentially associated with the medical therapy. Thus, in examples where the design assumption data is expressed in a risk assessment document, trial database 20 and other trial information may be structured based on the risk assessment document. In this example, if trial team 14 identified a particular type of stroke as a clinical outcome that is potentially associated with the medical therapy, trial team 14 may include a column in a table of trial database 20 to store data indicating the occurrence of the particular type of stroke. In some instances, trial team 14 may use one or more auto-populated electronic study templates to design trial database 20.

Trial team 14 may design trial database 20 such that the clinical outcomes are classified in trial database 20 according to the same set of definitions that was used to classify clinical outcomes in the design assumptions for the medical therapy. Hence, the clinical outcomes and design assumptions may be classified according to the same set of definitions, which may be standard definitions or customized definitions, but which provide a consistent lexicon for recording information associated with the design assumptions and clinical trial outcomes. For example, if design team 12 used the MedDRA dictionary to classify clinical outcomes in the design assumptions, trial team 14 may also use the MedDRA dictionary to classify clinical outcomes in trial database 20. In this way, if trial database 20 includes a field associated with a particular clinical outcome, a person may be able to use the set of definitions to precisely determine that the field stores data regarding the particular clinical outcome. Moreover, because trial team 14 uses the same set of definitions as design team 12, a person or computing system reviewing data in assumption database 18 and data in trial database 20 may be assured terms regarding clinical outcomes have the same meanings in the context of the design assumptions and trial database 20. In this manner, computing system 10 may be configured to link information relating to clinical outcomes with information relating to design-assumptions, thereby facilitating more effective evaluation of the design assumptions.

In addition, trial team 14 may design a trial protocol for the trial of the medical therapy (154). The trial protocol may describe the objectives, design, methodology, statistical considerations, and organization of the trial. For example, designing the trial protocol may involve preparing questionnaires designed to elicit information regarding the efficacy and safety of the medical therapy. In this example, trial team 14 may design one or more questionnaires to elicit information about clinical outcomes experienced by trial participants.

After trial team 14 has designed trial database 20 and designed the trial protocol, trial team 14 may collect trial outcome data from trial participants (156). Trial team 14 may input the trial outcome data to computing system 10 (158). Hence, computing system 10 may receive the trial outcome data from trial team 14 via an input interface, such as outcome input unit 52. In various examples, trial team 14 may input the trial outcome data in various ways. For example, outcome input unit 52 (FIG. 2) may provide a web server that hosts electronic forms. In this example, trial team 14 may use client computing devices to retrieve the electronic forms and fill the trial outcome data into the electronic forms. Outcome input unit 52 may receive trial outcome data inputted into the electronic forms and insert corresponding data into trial database 20. In some instances, outcome input unit 52 may adapt or modify the inputted trial outcome data prior to inserting the trial outcome data into trial database 20.

In another example, members of trial team 14 may use computing devices to input trial outcome data into one or more spreadsheet files or other types of data files. In this example, outcome input unit 52 may parse the trial outcome data from the spreadsheet files or other data files, and insert corresponding data into trial database 20.

Although the example of FIG. 4 shows operation 150 as a linear sequence of steps, trial team 14 may perform the steps of operation 150 in a non-linear manner. For example, trial team 14 may collect and input outcome data multiple times during the course of the trial. In another example, trial team 14 may concurrently collect and input the outcome data. In this example, computing system 10 may provide one or more electronic forms to a member of trial team 14. A member of trial team 14 may enter outcome data into the electronic forms while interviewing a trial participant.

In another example of how the steps of operation 150 may be performed in a non-linear manner, trial team 14 may finish at least a portion of the trial protocol for the trial after finishing design of trial database 20 (i.e., the database for the trial). Conventionally, designing a trial protocol typically involved identifying clinical outcomes that are potentially associated with the medical therapy. Identifying the clinical outcomes during design of the trial protocol may be a time consuming process. Hence, designers of the trial database for the trial would need to wait until the trial team identifies the clinical outcomes potentially associated with the medical therapy. However, in accordance with the techniques of this disclosure, design team 12 has already identified the clinical outcomes that are potentially associated with the medical therapy. Consequently, trial team 14 may design trial database based on the clinical outcomes identified by design team 12 without waiting for the clinical outcomes to be identified during design of the trial protocol.

In some examples, trial team 14 may use the assumption data to perform a pre-trial check of categories of clinical outcomes and expected or theoretical rates of occurrence of the clinical outcomes. This may help trial team 14 determine how or whether to conduct the trial.

Furthermore, in some examples, trial team 14 may report clinical outcomes of the trial (160). Trial team 14 may report the clinical outcomes in various ways. For example, trial team 14 may report the clinical outcomes using various templates. In some examples, computing system 10 may automatically populate one or more of the templates based on trial outcome data. Example templates may include a Clinical Investigation Plan template, an Investigator Brochure template, a Data Monitoring Committee template, a risk/benefit analysis template, a final report template, and so on. The data generated by trial team 14 to report the clinical outcomes may have various formats. For example, the data generated by trial team 14 to report the clinical outcomes may be formatted in extensible markup language (XML) controlled terms, a study data tabulation model (SDTM), an analysis data model (ADaM), or another format.

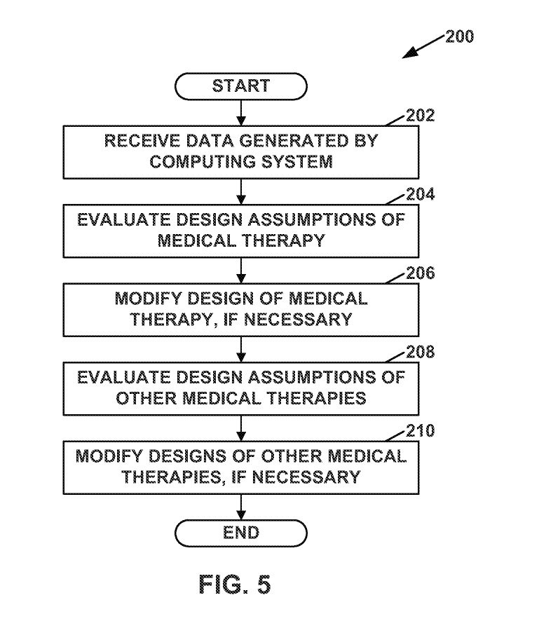

FIG. 5 is a flowchart that illustrates an example operation 200 performed by evaluation team 16 for the medical therapy. After evaluation team 16 starts operation 200, evaluation team 16 receives data generated by computing system 10 (202). The data associates design assumptions for the medical therapy with clinical outcomes experienced by the participants in the trial of the medical therapy. In various examples, evaluation team 16 receives various types of data generated by computing system 10. For example, computing system 10 may generate, and evaluation team 16 may receive, a list of subsystems and/or usage instructions associated in the design assumption data with clinical outcomes experienced by the trial participants.

In another example, data generation unit 54 may evaluate the accuracies of the design assumptions based on the trial outcome data. That is, data generation unit 54 may use the trial outcome data to determine whether a design assumption was accurate. In this example, data generation unit 54 may generate data that indicate results of evaluating the accuracies of the design assumptions based on the trial outcome data. For example, the design assumptions for the medical therapy may include a design assumption regarding the risk of a given clinical outcome that is potentially associated with a subsystem or usage instruction of the medical therapy. Computing system 10 may receive trial outcome data that indicate occurrences of the given clinical outcome in one or more participants in the trial. In this example, computing system 10 may automatically determine or provide trending data as to whether the subsystem or usage instruction was sufficient to mitigate the risk of the given clinical outcome. In other words, computing system 10 may determine whether measures, such as the subsystem or the usage instruction, reduced the risk of the given clinical outcome to an acceptable level.

In another example, data generation unit 54 may generate, during the trial, trend data that indicate occurrence frequencies of various clinical outcomes experienced by the trial participants. In this example, data generation unit 54 may evaluate the accuracies of the design assumptions in response to the trend data indicating that the occurrence frequency of one of the clinical outcomes exceeds a threshold, based on the trial outcome data. For example, data generation unit 54 may automatically evaluate the accuracies of design assumptions for subsystems that are potentially associated with infections when a particular number of trial participants experience infections.

Evaluation team 16 may then use the data to evaluate design assumptions of the medical therapy (204). In various examples, evaluation team 16 may use the data to evaluate the design assumptions in various ways. For example, the data may list the subsystems and usage instructions of the medical therapy that are potentially associated with a given clinical outcome experienced by trial participants. This list of subsystem and usage instructions may be significantly shorter than a full list of all subsystems of and usage instructions for the medical therapy. In this example, evaluation team 16 may analyze the trial outcome data and the design assumptions regarding the subsystems and usage instructions to isolate one or more subsystems or usage instructions that may be responsible for causing the given clinical outcome. Because the list generated by computing system 10 may be shorter than the full list, evaluation team 16 may be able to perform the analysis from the list generated by computing system 10 more efficiently than from the full list. In this way, and in other ways, the techniques of this disclosure may automate work and reduce costs in managing increasingly larger studies.

In another example, the data generated by computing system 10 may indicate accuracies of the design assumptions of the medical therapy. For example, computing system 10 may automatically evaluate data, such as numeric, alphanumeric or other data, for clinical outcomes expected with the design assumptions and the actual clinical outcomes. Computing system 10 may automatically identify inconsistencies between clinical outcomes expected based on the design assumptions and actual clinical outcomes. In some cases, the computing system 10 may compare expected data for clinical outcomes to actual data for clinical outcomes. In some cases, computing system 10 may compare actual data to thresholds associated with expected data, or to ranges of expected data. As an example, computing system 10 may compare an expected number of unintended shocks, generated based on design assumptions, to an actual number of unintended shocks among patients in an actual trial, and determine whether the actual number deviates from the expected number, or deviates from the expected number by a predetermined amount. If so, computing system 10 may automatically generate data, such as flags, comments, or the like, to identify an instance of substantial deviation, such that evaluation team 16 may evaluate the deviation. In this example, evaluation team 16 may use the data generated by computing system 10 to evaluate the design assumptions of the medical therapy by reviewing and validating the data.

In various examples, evaluation team 16 may use the data to evaluate the design assumptions of the medical therapy at various times. For example, evaluation team 16 may use the data to evaluate the design assumptions of the medical therapy prior to an end of the trial. Consequently, if a design assumption proves to be inaccurate, evaluation team 16 may be in a better position to determine whether to terminate or continue the trial than if evaluation team 16 only evaluated the design assumptions for the medical therapy after the end of the trial for the medical therapy. In other words, evaluation team 16 may perform a risk/benefit analysis regarding the trial and the medical therapy. In some examples, evaluation team 16 may evaluate the design assumptions on a cyclical basis.

Following evaluation of the design assumptions, evaluation team 16 may modify the design of the medical therapy, if necessary, in response to an analysis of the data generated by computing system 10 (206). For example, the evaluation of the design assumptions may reveal that a design assumption regarding a particular subsystem is inaccurate. In response, evaluation team 16 may reformulate one or more design assumptions regarding the subsystem and may redesign the medical therapy. For instance, evaluation team 16 may, as a result of using the data to evaluate the design assumptions of the medical therapy, determine that an amount of insulation on a particular subsystem of the medical therapy is insufficient to prevent unintended electrical shocks. In this instance, evaluation team 16 may make this determination based on a number of unintended shocks indicated by actual clinical trial outcomes to an expected number of unintended shocks indicated by the design assumptions. Furthermore, in this instance, evaluation team 16 (or another group of people) may modify the design of the medical therapy to increase the amount of insulation on the particular subsystem. In some examples, a device designed to deliver the medical therapy may later be manufactured in accordance with the modified design of the medical therapy.

In some examples, computing system 10 may generate and evaluation team 16 may receive information indicating other medical therapies that include the subsystems or usage instructions associated with the clinical outcomes experienced by the trial participants. Evaluation team 16 may evaluate the design assumptions of other medical therapies based on the evaluations of the design assumptions of the medical therapy (208). For example, if a first medical therapy and a second medical therapy include the same subsystem and evaluation team 16 determines, based on trial outcome data for the first medical therapy that a design assumption regarding the subsystem is inaccurate or should be revised, evaluation team 16 may reevaluate the design assumptions for the second medical therapy. For example, if the first and second therapies use the same electrical lead or leads and evaluation team 16 revises the design assumptions regarding the lead or leads, evaluation team 16 may modify the first and the second therapies based on the evaluation of the design assumptions of the first medical therapy. In some examples, computing device 10 or evaluation team 16 may pool categories of clinical outcomes across trials. Thus, if evaluation of the medical therapy indicates clinical outcomes yielding adverse events that deviate from the design assumptions, the design assumptions may be evaluated for possible modification.

Evaluation team 16 may modify the designs of the other medical therapies, if necessary (210). For example, if evaluation team 16 determines, based on trial outcome data for a first medical therapy, that a particular amount of insulation on a subsystem is insufficient to prevent an electric shock; evaluation team 16 (or another group of people) may modify the designs of other medical therapies that include the subsystem to increase the amount of insulation on the subsystem.

Although the discussion above of FIG. 5 describes evaluation team 16 as performing all steps of operation 200, other teams may perform one or more steps of operation 200. For example, design team 12 may modify the design of the medical therapy instead of evaluation team 16. Moreover, different design and/or evaluation teams may evaluate the design assumptions of the other medical therapies.

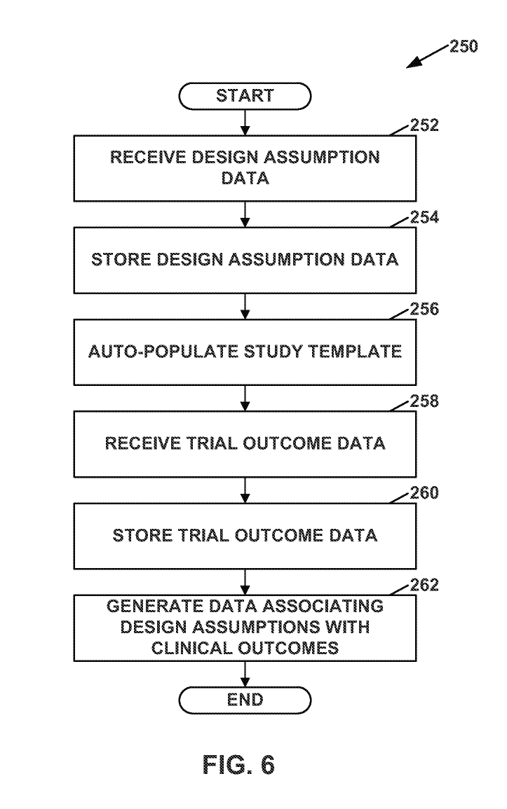

FIG. 6 is a flowchart that illustrates an example operation 250 performed by computing system 10. After operation 250 starts, assumption input unit 50 may receive design assumption data (252). In response to receiving the design assumption data, assumption input unit 50 may store the design assumption data in assumption database 18 (254).

In the example of FIG. 6, computing system 10 may store or access one or more electronic study templates. Each of the electronic study templates may be an electronic form having data entry fields. In accordance with the techniques of this disclosure, data generation unit 54 may auto-populate one or more electronic study templates based on the design assumption data (256). When data generation unit 54 auto-populates an electronic study template based on the design assumption data, data generation unit 54 may generate the electronic study template such that the electronic study template includes data entry fields for collecting data regarding the clinical outcomes associated with the design assumptions. For example, if the design assumption data includes a design assumption regarding the risk of an electrical shock posed by a particular subsystem, such as a subsystem comprising a set of one or more leads, data generation unit 54 may auto-populate an electronic study template such that the electronic study template includes one or more data entry fields for collecting information about electrical shocks, e.g., number, frequency, shock magnitude, or the like.

Data generation unit 54 may auto-populate various types of electronic study templates. For example, data generation unit 54 may auto-populate case report forms (CRFs), informed consent forms (ICFs), safety templates, risk/benefit decision templates, and other types of electronic forms that include data entry fields. In some instances, regulatory agencies may promulgate the electronic study templates and require filled versions of the electronic study templates as parts of an application for marketing approval for the medical therapy. For instance, the electronic study templates may be used to generate regulatory deliverables. In some instances, the electronic study templates are industry-standard study templates. In other words, the electronic study templates may conform to a standard that is in use across a particular industry. In some instances, data generation unit 54 may use a standard Clinical Data Interchange Standards Consortium (CDISC) protocol or Clinical Data Acquisition Standards Harmonization (CDASH) protocol, or a LAB model to auto-populate the electronic study templates.

Auto-populating electronic study templates based on the design assumption data may enable trial team 14 to obtain the electronic study templates prior to completion of a trial protocol for the trial. This may be more efficient than waiting for completion of the trial protocol to obtain the electronic study templates. Trial team 14 may use the electronic study templates when designing trial database 20.

Furthermore, outcome input unit 52 may receive trial outcome data (258). Trial team 14 may use the electronic study templates to provide the trial outcome data to outcome input unit 52. For instance, trial team 14 may use auto-populated case report forms to provide the trial outcome data to outcome input unit 52. In response to receiving the trial outcome data, outcome input unit 52 stores the trial outcome data in trial database 20 (260).

After computing system 10 has received the design assumption data for the medical therapy and trial outcome data for a trial of the medical therapy, data generation unit 54 may generate data associating the design assumptions with the clinical outcomes experienced by the trial participants (262). In various examples, data generation unit 54 may generate the data at various times. For example, data generation unit 54 may generate the data before the end of the trial of the medical therapy. In other examples, data generation unit 54 may generate the data after the end of the trial of the medical therapy.

In various examples, data generation unit 54 may perform various actions to generate the data. Evaluation team 16 may use the data generated by computing system 10 for various purposes. For example, data generation unit 54 may execute one or more queries on trial database 20 to retrieve information regarding the prevalence of a particular clinical outcome. In this example, data generation unit 54 may determine whether the prevalence of the particular clinical outcome deviates from an expected clinical outcome. For example, data generation unit 54 may determine whether the prevalence of the particular clinical outcome is above a particular threshold. For example, a particular threshold may be generated based on expected clinical trial outcome data for one or more pertinent design assumptions. If the prevalence of the particular clinical outcome deviates from an expected prevalence of the particular clinical outcome, data generation unit 54 may execute one or more queries on assumption database 18 to retrieve information identifying the design assumptions associated with the particular clinical outcome. For instance, data generation unit 54 may retrieve information identifying subsystems and usage instructions for the medical therapy that may potentially cause the particular clinical outcome. In some examples, data generation unit 54 may output the identified design assumptions. In addition, in some examples, data generation unit 54 may automatically generate a flag, comment or message to identify the deviation and permit further evaluation by members of evaluation team 16. For example, evaluation team 16 may evaluate the accuracies of identified design assumptions.

Moreover, in some examples, data generation unit 54 may automatically evaluate the accuracies of identified design assumptions and generate data indicating which of the identified design assumptions are most likely to be inaccurate. Data generation unit 54 may use a variety of techniques to determine whether one or more of the identified design assumptions are inaccurate. For example, data generation unit 54 may use artificial intelligence (AI) methods, such as an expert system, to determine which one of the identified design assumptions is most likely to be inaccurate.

Furthermore, in some examples, data generation unit 54 may identify, in response to determining that a design assumption regarding a given subsystem of the medical therapy is inaccurate or may be inaccurate, other medical therapies that include the given subsystem. Data generation unit 54 may output a list of the identified medical therapies. This may assist evaluation team 16 in re-evaluating the design assumptions for the other medical therapies. If a design assumption is considered for a sub-system for one medical therapy, data generation unit 54 may permit evaluation team 16 to simultaneously consider the sub-system in the context of one or more other medical therapies.

FIG. 7 is a block diagram of an example configuration of a computing device 300. Computing device 300 is a physical device that processes information. In some examples, computing system 10 comprises one or more computing devices having configurations similar to the configuration of computing device 300.

Computing device 300 comprises a data storage system 302, a memory 304, a secondary storage system 306, a processing system 308, an input interface 310, a display interface 312, a communication interface 314, and one or more communication media 316. Communication media 316 enable data communication between processing system 308, input interface 310, display interface 312, communication interface 314, memory 304, and secondary storage system 306. Readers will understand that computing device 300 can include components in addition to those shown in the example of FIG. 7. Furthermore, readers will understand that some computing devices do not include all of the components shown in the example of FIG. 7.

A computer-readable medium is a medium from which processing system 308 can read data. Computer-readable media include computer storage media and communications media. Computer storage media include physical devices that store data for subsequent retrieval. Computer storage media are not transitory. For instance, computer storage media do not exclusively comprise propagated signals. Computer storage media include volatile storage media and non-volatile storage media. Example types of computer storage media include random-access memory (RAM) units, read-only memory (ROM) devices, solid state memory devices, optical discs (e.g., compact discs, DVDs, BluRay discs, etc.), magnetic disk drives, electrically-erasable programmable read-only memory (EEPROM), programmable read-only memory (PROM), magnetic tape drives, magnetic disks, and other types of devices that store data for subsequent retrieval. Communication media include media over which one device can communicate data to another device. Example types of communication media include communication networks, communications cables, wireless communication links, communication buses, and other media over which one device is able to communicate data to another device.

Data storage system 302 is a system that stores data for subsequent retrieval. In the example of FIG. 7, data storage system 302 comprises memory 304 and secondary storage system 306. Memory 304 and secondary storage system 306 store data for later retrieval. In the example of FIG. 7, memory 304 stores computer-executable instructions 318 and program data 320. Secondary storage system 306 stores computer-executable instructions 322 and program data 324. Physically, memory 304 and secondary storage system 306 each comprise one or more computer storage media.

Processing system 308 is coupled to data storage system 302. Processing system 308 reads computer-executable instructions from the data storage system 302 and executes the computer-executable instructions. Execution of the computer-executable instructions by processing system 308 configures and/or causes computing device 300 to perform the actions indicated by the computer-executable instructions. For example, execution of the computer-executable instructions by processing system 308 can configure and/or cause computing device 300 to provide Basic Input/Output Systems, operating systems, system programs, application programs, or can configure and/or cause computing device 300 to provide other functionality.

Processing system 308 reads the computer-executable instructions from one or more computer-readable media. For example, processing system 308 can read and execute computer-executable instructions 318 and 322 stored on memory 304 and secondary storage system 306. In some embodiments, computing device 300 can provide assumption input unit 50, outcome input unit 52, and/or data generation unit 54 when processing system 308 executes computer-executable instructions 318 and/or computer-executable instructions 322.

Processing system 308 comprises one or more processing units 326. Processing units 326 comprise physical devices that execute computer-executable instructions. In various embodiments, processing units 326 can comprise various types of physical devices that execute computer-executable instructions. For example, one or more of processing units 326 can comprise a microprocessor, a processing core within a microprocessor, a digital signal processor, a graphics processing unit, or another type of physical device that executes computer-executable instructions.

Input interface 310 enables computing device 300 to receive input from an input device 328. Input device 328 comprises a device that receives input from a user. In various embodiments, input device 328 comprises various types of devices that receive input from users. For example, input device 328 can comprise a keyboard, a touch screen, a mouse, a microphone, a keypad, a joystick, a brain-computer interface device, or another type of device that receives input from a user. In some embodiments, input device 328 is integrated into a housing of computing device 300. In other embodiments, input device 328 is outside a housing of computing device 300.

Display interface 312 enables computing device 300 to display output on a display device 330. Display device 330 is a device that displays output. Example types of display devices include monitors, touch screens, display screens, televisions, and other types of devices that display output. In some embodiments, display device 330 is integrated into a housing of computing device 300. In other embodiments, display device 330 is outside a housing of computing device 300.

Communication interface 314 enables computing device 300 to send and receive data over one or more communication media. In various embodiments, communication interface 314 comprises various types of devices. For example, communication interface 314 can comprise a Network Interface Card (NIC), a wireless network adapter, a Universal Serial Bus (USB) port, or another type of device that enables computing device 300 to send and receive data over one or more communication media.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various embodiments of the invention have been described. These and other embodiments are within the scope of the following claims.

What is claimed is:

1. A method for evaluating a medical therapy, the method comprising:
receiving, in a computing system, design assumption data prior to a trial of the medical therapy, the design assumption data indicating design assumptions regarding clinical outcomes that are associated with the medical therapy;
receiving, in the computing system, trial outcome data that indicate clinical outcomes experienced by participants in the trial of the medical therapy; and
generating, by the computing system, data associating the design assumptions with the clinical outcomes experienced by the participants in the trial.

2. The method of claim 1, wherein the design assumptions include design assumptions regarding clinical outcomes that are associated with subsystems of the medical therapy.

3. The method of claim 1, wherein the design assumptions include design assumptions regarding clinical outcomes that are associated with usage instructions for the medical therapy.

4. The method of claim 1, wherein the design assumptions include design assumptions regarding measures to mitigate risks of the clinical outcomes.

5. The method of claim 1, wherein clinical outcomes are classified in the design assumption data and the trial outcome data according to a same set of definitions.

6. The method of claim 5, further comprising storing the trial outcome data in a database for the trial, the database designed based at least in part on the set of definitions.

7. The method of claim 6, further comprising parts of a trial protocol based on design assumptions acquired from the database for the trial.

8. The method of claim 5, wherein the set of definitions is the Medical Dictionary for Regulatory Activities (MedDRA).

9. The method of claim 5, further comprising autopopulating electronic study templates for the trial based on the design assumption data.

10. The method of claim 9, wherein the electronic study templates are industry standard electronic study templates.

11. The method of claim 1, further comprising evaluating accuracies of the design assumptions based on the trial outcome data.

12. The method of claim 11,
wherein the design assumptions include a design assumption regarding a risk of a given clinical outcome that is associated with a subsystem or usage instruction the medical therapy;
wherein receiving the trial outcome data comprises receiving data indicating occurrences of the given clinical outcome in one or more of the participants in the trial; and
wherein evaluating the accuracies of the design assumptions comprises determining whether the subsystem or the usage instruction was sufficient to mitigate the risk of the given clinical outcome.

13. The method of claim 12, wherein the accuracies of the design assumptions are evaluated prior to an end of the trial.

14. The method of claim 13, further comprising generating, during the trial, trend data that indicate occurrence frequencies of the clinical outcomes, the accuracies of the design assumptions in response to the trend data indicating that the occurrence frequency of one of the clinical outcomes exceeds a threshold.

15. The method of claim 8,
wherein the medical therapy is a first medical therapy; and
wherein the method further comprises modifying design assumptions for a second medical therapy based on results of evaluating the accuracies of the design assumptions regarding the features of the first medical therapy.

16. The method of claim 8,
wherein the medical therapy includes a given subsystem; and
wherein the method further comprises identifying, in response to determining that a design assumption regarding the given subsystem is not accurate, one or more other medical therapies that include the given subsystem.

17. The method of claim 1, wherein receiving the design assumption data comprises receiving a risk assessment document that complies with a standard, the risk assessment document indicating the design assumptions.

18. The method of claim 1, further comprising:
storing the trial outcome data in a data warehouse; and
performing a data mining operation on the data warehouse to determine patterns of clinical outcomes in the participants.

19. The method of claim 1, wherein the design assumptions include design assumptions regarding electrical risks, mechanical risks, environmental risks, user-derived risks, non-user events, and biological risks.

20. The method of claim 1, further comprising:
modifying a design of the medical therapy in response to an analysis of the data; and
manufacturing the medical therapy in accordance with the modified design of the medical therapy.

21. The method of claim 1, wherein the medical therapy is a medical device.

22. The method of claim 1, wherein the trial is a clinical trial.

23. A computing system that comprises:
a data storage system that stores computer-executable instructions; and
one or more processing units coupled to the data storage system, the one or more processing units configured to execute the instructions, execution of the instructions by the one or more processing units configuring the computing system to:
receive design assumption data prior to a trial of a medical therapy, the design assumption data indicating design assumptions regarding clinical outcomes that are associated with the medical therapy;
receive trial outcome data that indicate clinical outcomes experienced by participants in the trial of the medical therapy; and
generate data associating the design assumptions with the clinical outcomes experienced by the participants in the trial.

24. The computing system of claim 23, wherein the design assumptions include design assumptions regarding clinical outcomes that are associated with a subsystem of the medical therapy.

25. The computing system of claim 23, wherein the design assumptions include design assumptions regarding measures to mitigate risks of the clinical outcomes.

26. The computing system of claim 23, wherein clinical outcomes are classified in the design assumption data and the trial outcome data according to a same set of definitions.

27. The computing system of claim 26, wherein execution of the instructions by the one or more processing units configures the computing system to autopopulate electronic study templates for the trial based on the design assumption data.

28. The computing system of claim 23, wherein execution of the instructions by the one or more processing units configures the computing system to evaluate accuracies of the design assumptions based on the trial outcome data.

29. The computing system of claim 28,
wherein the design assumptions include a design assumption regarding a risk of a given clinical outcome that is associated with a subsystem or usage instruction of the medical therapy;
wherein the trial outcome data indicates occurrences of the given clinical outcome in one or more of the participants in the trial; and
wherein execution of the instructions by the one or more processors configures the computing system to evaluate the accuracies of the design assumptions at least in part by configuring the computing system to determine whether the subsystem or the usage instruction was sufficient to mitigate the risk of the given clinical outcome.

30. The computing system of claim 28, wherein the computing system evaluates the accuracies of the design assumptions prior to an end of the trial.

31. The computing system of claim 30, wherein execution of the instructions by the one or more processing units configures the computing system to generate trend data that indicate occurrence frequencies of the clinical outcomes during the trial, the computing system evaluating the accuracies of the design assumptions in response to the trend data indicating that the occurrence frequency of one of the clinical outcomes exceeds a threshold.

32. The computing system of claim 28,
wherein the medical therapy is a first medical therapy; and
wherein execution of the instructions by the one or more processing units causes the computing system to identify inaccurate design assumptions for a second medical therapy based on results of evaluating the design assumptions for the first medical therapy.

33. The computing system of claim 23, wherein the medical therapy is a medical device.

34. The computing system of claim 23, wherein the trial is a clinical trial.

35. A computer storage medium that stores computer-executable instructions, execution of the instructions by one or more processing units of a computing system configuring the computing system to:
receive design assumption data prior to a trial of the medical therapy, the design assumption data indicating design assumptions regarding clinical outcomes that are associated with the medical therapy;
receive trial outcome data that indicate clinical outcomes experienced by participants in the trial of the medical therapy; and
generate data associating the design assumptions with the clinical outcomes experienced by the participants in the trial.
